(19) United States
(12) Patent Application Publication
(10) Pub. No.: US 2008/0021724 A1
(43) Pub. Date: Jan. 24, 2008

(54) System and process for educating and making donations to charities

(76) Inventor: Eric Garfinkel, Great Falls, VA (US)

Correspondence Address: MCGUIREWOODS, LLP, 1750 TYSONS BLVD, SUITE 1800, MCLEAN, VA, 22102, US

(21) Appl. No.: 11/826,651

(22) Filed: Jul. 17, 2007

Related U.S. Application Data
(60) Provisional application No. 60/831,202, filed on Jul. 17, 2006.

(51) Int. Cl. G06Q 30/00; G09B 19/08

(52) U.S. Cl. 705/1; 434/307 R

(57) ABSTRACT

A computer-implemented method for charity education and donation is performed by displaying various objects. Each object corresponds to a charity and linked to educational content related to the corresponding charity. In response to a member's selection of one of the objects, the educational content related to the corresponding charity is displayed. In response to the member's selection of an amount of donation for the selected charity, the selected amount of donation is transferred to the selected charity.

### CROSS-REFERENCE TO RELATED APPLICATIONS

This application claims priority under 35 U.S.C. §119(e) to provisional U.S. Patent Application No. 60/831,202, filed on Jul. 17, 2006, the disclosure of which is expressly incorporated by reference herein in its entirety.

### BACKGROUND OF THE INVENTION

1. Field of the Invention

The invention is directed to a system and process for charitable education and more particularly, to a system and process for on-line education and donation.

2. Related Art

Ever since its introduction, the Internet has significantly changed how people approach commercial and non-commercial transactions. Since a customer can browse an on-line catalog from a web site offered by a commercial entity (e.g., a store) and place an order for a product or service offered by the commercial entity, it is no longer a barrier that the commercial entity is located very distant from a customer. Similarly, many charity organizations are operating web sites, where a visitor from anywhere can acquire information about the charity and use the web site to make a monetary contribution to the charity instantly (e.g., credit card). However, the content of these web sites is usually intended for promoting each individual organization's cause. Thus, these web sites are generally not informative to those who want to see what kind of charitable activities are available for contribution. Although some organizations offer information on other charities on their websites, the information is generally very limited (e.g., name, address, phone number, map and/or URL) and hardly educational to children. Also, since most children do not have a credit card or other on-line payment method, they are virtually excluded from making a contribution even if they know which charitable activity they want to contribute, unless their parents provide their credit card numbers.

Accordingly, there is a need for an improved approach for charity education and donation.

### SUMMARY OF THE INVENTION

The invention meets the foregoing need and allows children to be well informed and educated about various charitable causes and activities and to make a monetary contribution to charitable activities and causes of their choice, which results in a significant educational effect and other advantages apparent from the discussion herein.

Accordingly, in one aspect of the invention a computer-implemented method for charity education and donation is performed by providing a web site that displays various objects. Each object corresponds to a charity and is linked to educational content related to the corresponding charity. In response to a member's selection of one of the objects, the educational content related to the corresponding charity is displayed. In response to the member's selection of an amount of donation for the selected charity. The selected amount of donation is transferred to the selected charity.

A parent, relative, or other may transfer money for another, such as a child to an account. As the recipient selects charities and designates donation amounts, money is transferred from the account to the designated charity.

Additional features, advantages, and embodiments of the invention may be set forth or apparent from consideration of the following detailed description, drawings, and claims. Moreover, it is to be understood that both the foregoing summary of the invention and the following detailed description are exemplary and intended to provide further explanation without limiting the scope of the invention as claimed.

### BRIEF DESCRIPTION OF THE DRAWINGS

The accompanying drawings, which are included to provide a further understanding of the invention, are incorporated in and constitute a part of this specification, illustrate embodiments of the invention and together with the detailed description serve to explain the principles of the invention. No attempt is made to show structural details of the invention in more detail than may be necessary for a fundamental understanding of the invention and the various ways in which it may be practiced. In the drawings:

FIG. 1 is a block diagram depicting an approach for charity education and donation according to the principles of the invention;

FIG. 2 is a flow chart depicting an approach for creating an account for charity education and donation according to the principles of the invention;

FIG. 3 is a flow chart depicting an approach for educating and making donations according to the principles of the invention;

FIG. 4 is a screen shot of a web page for a charity education and donation organization containing various links according to the principles of the invention;

FIG. 5 is a screen shot of a web page linked to the web page of FIG. 4 containing objects corresponding to various charity categories according to the principles of the invention;

FIG. 6 is a screen shot of a web page linked to the web page of FIG. 5 containing object corresponding to various charities according to the principles of the invention; and

FIG. 7 is a screen shot of a web page linked to the web page of FIG. 6 containing textual and graphical illustration of a charity according to the principles of the invention.

### DETAILED DESCRIPTION OF THE INVENTION

The embodiments of the invention and the various features and advantageous details thereof are explained more fully with reference to the non-limiting embodiments and examples that are described and/or illustrated in the accompanying drawings and detailed in the following description. It should be noted that the features illustrated in the drawings are not necessarily drawn to scale, and features of one embodiment may be employed with other embodiments as the skilled artisan would recognize, even if not explicitly stated herein. Descriptions of well-known components and processing techniques may be omitted so as to not unnecessarily obscure the embodiments of the invention. The examples used herein are intended merely to facilitate an understanding of ways in which the invention may be practiced and to further enable those of skill in the art to practice the embodiments of the invention. Accordingly, the examples and embodiments herein should not be construed as limiting the scope of the invention, which is defined solely by the appended claims and applicable law. Moreover, it is noted that like reference numerals represent similar parts throughout the several views of the drawings.

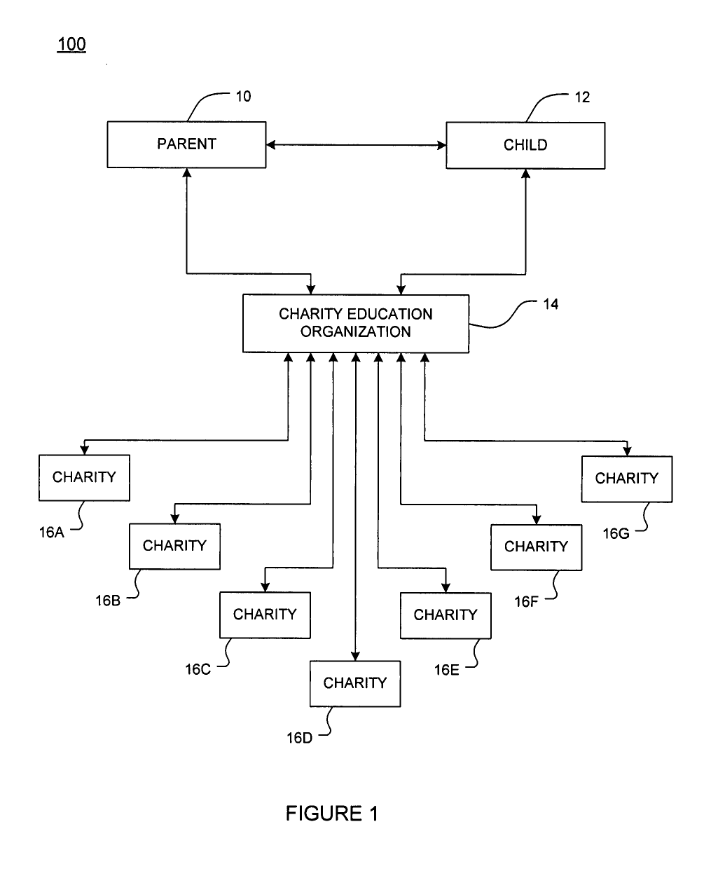

As mentioned above, conventional on-line charity websites are often not child-friendly because these websites are simply not created for the purpose of educating children about various charitable activities and it is very difficult for children to make an on-line donation. To solve these problems, FIG. 1 is a block diagram 100 that illustrates an approach for charity education and donation, in which children may search and learn about various charitable activities and help teach themselves to make wise decisions in making donations, according to an embodiment of the invention. A parent 10 or other adult, who may be interested in educating a child 12, may open an account at a charity education organization 14 and deposit a certain amount of funds into the account. This may be done by visiting the organization's 14 website where the parent 10 may open an account and may use his or her credit card to deposit the funds into the account. While the example is described with reference to credit card payments, it is understood that other payment methods may be used to deposit the funds into the account. The parent 10 may select or be given a login name and password to protect his or her account from any unauthorized access. Once the account is created by the parent 10, the child 12 may be given access to the organization's online charity education and donation website. For example, the organization 14 may issue a membership card with account access information for the child 12. The account access information may include a URL and/or access code for the charity education and donation website.

To educate the child 12 or any other visitors, the charity education organization 14 may collect information from charities 16A, 16B, 16C, 16D, 16E, 16F, 16G. The information may include, but is not limited to, the charity name, address, URL, geographical location, detailed charitable activities, photos, audio/video clips and the like. This information may be used to create internet-based communication data, such as HTML files for displaying web pages on a computer screen. For example, one or more web pages may be dedicated to a single charity, and each web page may contain textual, graphical and/or multimedia content of the charity such as a charity activity description, maps, pictures, audio/video clips or the like, such that the child 12 or any person who visits the website of the organization 14 may educate himself or herself about the charity and its causes and activities.

All of the web pages dedicated to the charities 16A, 16B, 16C, 16D, 16E, 16F, 16G may be linked from one or more “list” web pages, in which the links to the web pages dedicated to the charities 16A, 16B, 16C, 16D, 16E, 16F, 16G are listed in static manners, such as an alphabetical or chronological order or the like. Alternatively, the web pages may be linked in a more dynamic manner. For example, based on the information from the charities 16A, 16B, 16C, 16D, 16E, 16F, 16G, the charities 16A, 16B, 16C, 16D, 16E, 16F, 16G may be categorized, for example by their geographic locations, types of charitable activities, popularity or the like. Also, categorization may be further performed such that each category may be divided into a number of sub-categories. For example, after choosing “animal” as the main category, the member 12 or any visitor may further choose “Africa” as a sub-category to narrow down the search to the animal-related charities located in Africa. If necessary, each sub-category may be further divided into even smaller and more specific categories. Further, by storing collected information in a database, the member 12 or visitor may be able to perform keyword searches. For example, the member 12 or any visitor may use “poverty” as the keyword for categorization and the database may be able to provide a list of charities related to the keyword “poverty.”

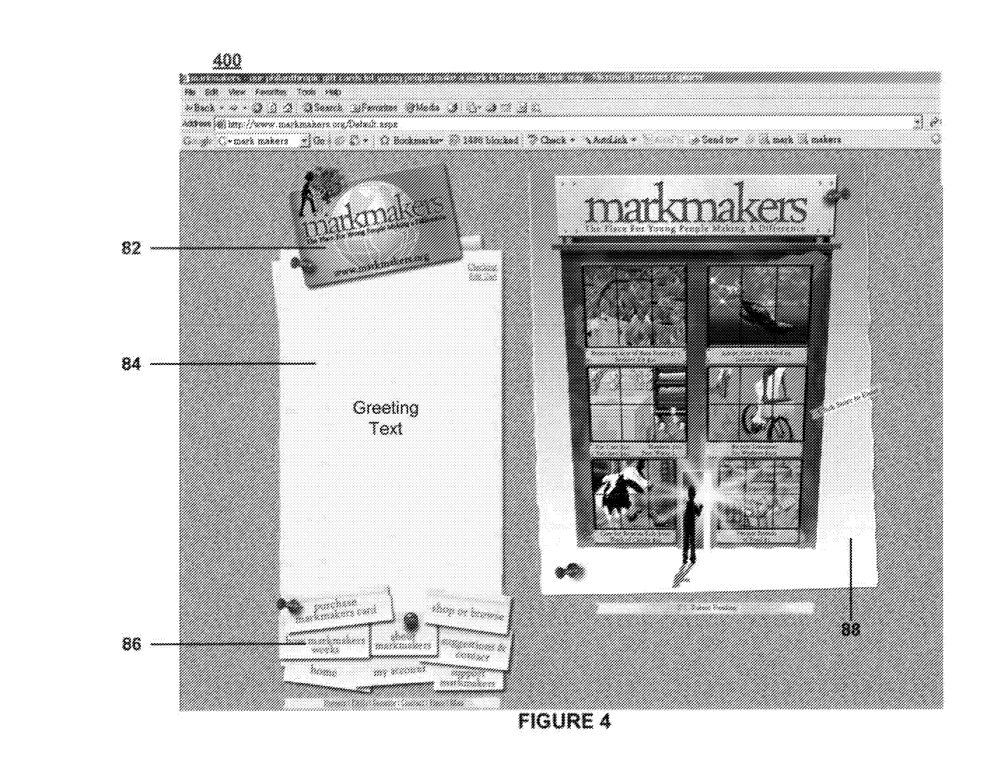

The dynamic approach of linking the web pages created with textual, graphical and/or multimedia content may have maximum educational effect on children. For example, FIGS. 4, 5, 6, and 7 are screen shots of the web pages, according to an embodiment of the invention. FIG. 4 shows a web page 400, which may be a home page for a charity education organization, arbitrarily named “MarkMakers.” The web page 400 may show various textual, graphical and/or multimedia objects on the screen. For example, the object 82 is a graphical representation of the membership card issued to the child 12. The object 84 is textual content directed to a greeting, brief introduction to the organization 14, how it works, and so on. The object 86 may contain various links to other web pages of the website. The object 88 graphically illustrates a shop with six windows and each window shows different charitable activities such as environmental protection, medical aids, food aids, animal protection, transportation support, or the like. Such a graphical representation of charitable activities may stimulate and cause curiosity to the child 12 or visitor.

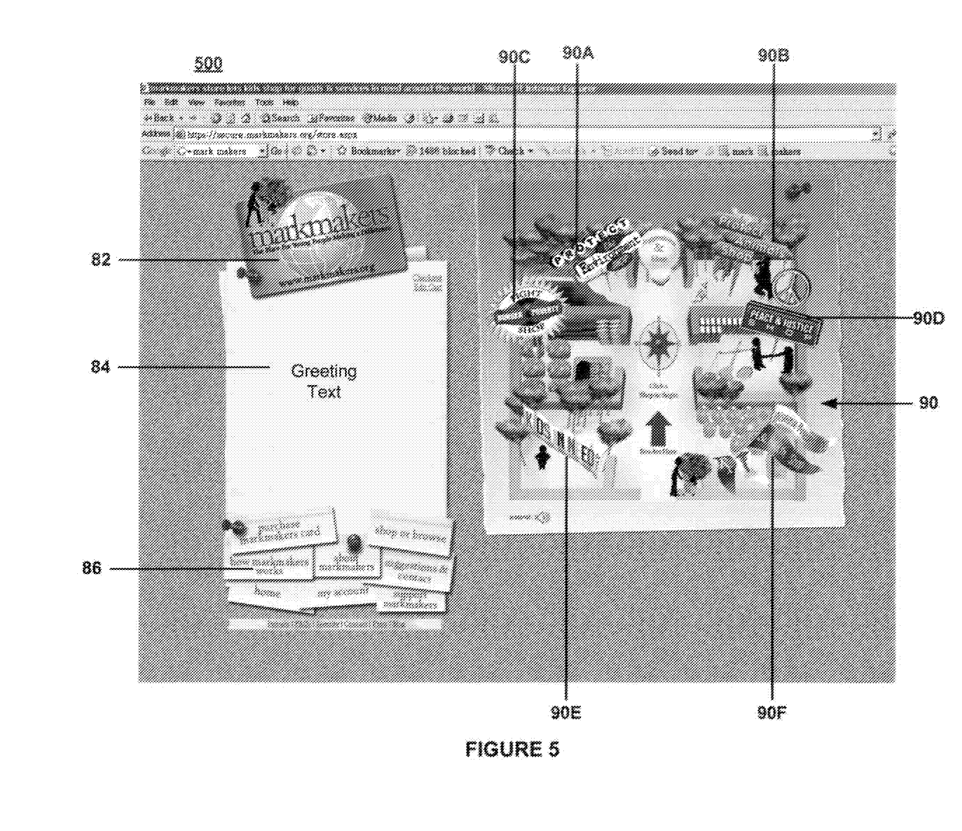

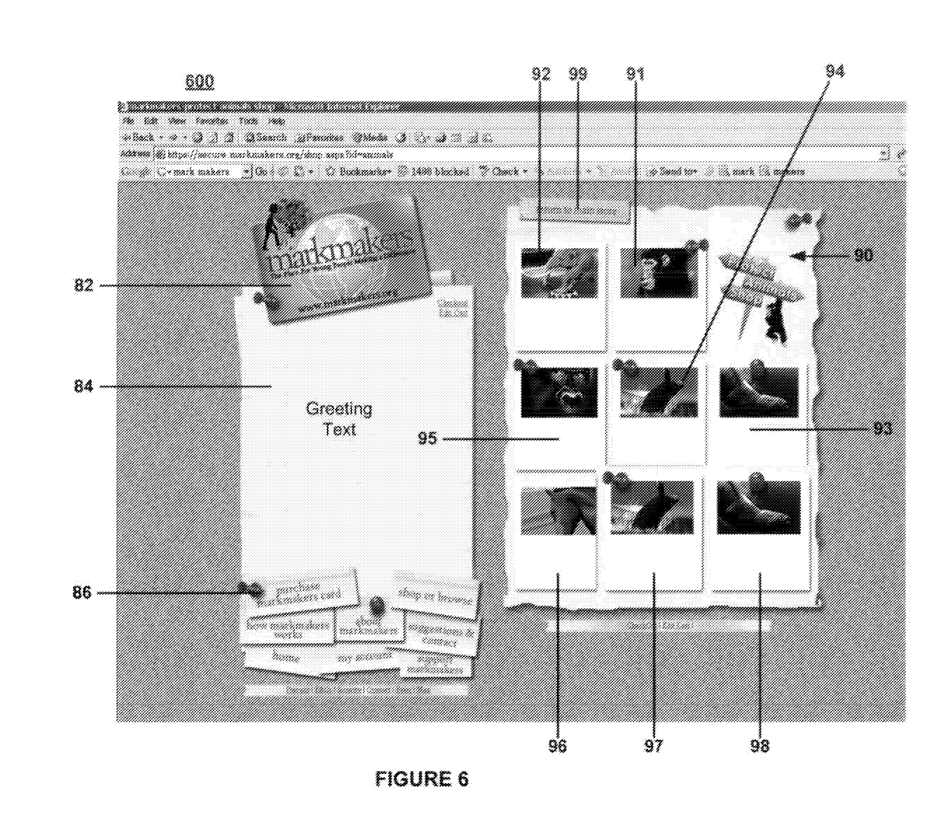

In this example, the object 88 is linked to a web page 500 shown in FIG. 5, where a new object 90 is displayed while the objects 82, 84, 86 from the web page 400 may be displayed on the same locations. The object 90 is a graphical illustration of a market place featuring various shops named “Protect the Environment” 90A, “Protect Animals” 90B, “Fight Hunger & Poverty” 90C, “Peace & Justice” 90D, “Kid in Need” 90E and “Disease Prevention & Health” 90F. Each shop represents one of the categories discussed above and is linked to another web page dedicated to each category. For example, by using a mouse or other known input device, the child 12 may select the “Protect Animals” shop 90B, which is linked to a web page 600 shown in FIG. 6.

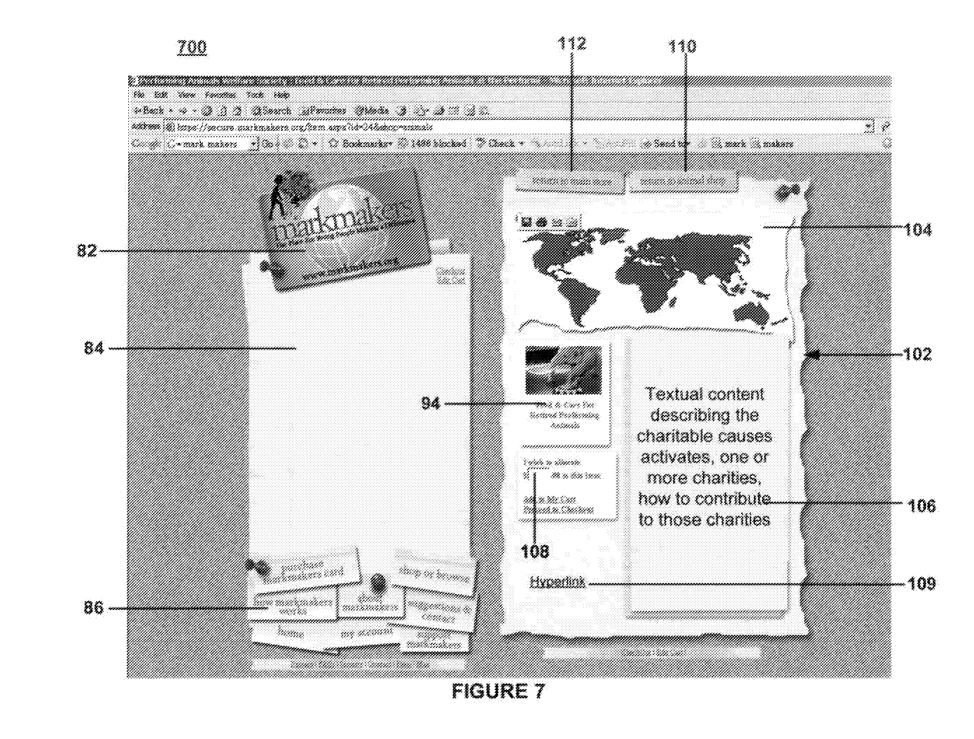

The web page 600 of FIG. 6 shows a new object 90, which displays various objects 91, 92, 93, 94, 95, 96, 97 and 98 containing pictures of various animals. Each of the objects 91, 92, 93, 94, 95, 96, 97 and 98 may further contain textual, graphical or multi-media content to help the child 12 understand the details of the charitable activities. For example, the object 93 further contains textual content, such as “Provide Shelter & Food for Retired Performing Animals.” If the child 12 finds the cause of the object 93 compelling, he or she may click the object 93, which is linked to a web site 700 shown in FIG. 7. If the child 12 wants to browse different categories, he or she may click a link 99, which is linked back to the web page 500 shown in FIG. 5.

As shown in FIG. 7, the object 102 contains several textual and graphical objects, such as a map 104 showing the location of the charitable activities, the object 94 from the web page 600 in FIG. 6, an object 106 containing textual content describing the charitable causes and activates, one or more charities, how to contribute to those charities, and/or the like. After reviewing various content of the object 102, the child 12 may enter an amount of contribution in the input box 108 and click a link 109 if he or she feels compelled. If the child 12 wants to browse different categories or activities, he or she can click a link 112 to go back to the web page 500 in FIG. 5 or a link 110 to go back to the web page 600 in FIG. 6. If the amount of contribution exceeds the account balance, an error message may be displayed with a link to enter a new contribution amount. Once a contribution process is completed, the organization will send a notice or a thank you note to the parent 10 advising the parent 10 of the contribution including the dollar value made by the child 12. This notice process functionality may be an automatic operation within the system. In addition, the system may also include functionality to allow the child 12 to compose and send a thank you note to the parent 10 that will accompany the above-noted notice that furthers the educational aspects of the invention. Finally, the sum of the contributions from the members may be transferred to the corresponding charities regularly, such as weekly or monthly basis.

The system and process may also include automatic notification functionality for when contributions are not made. In this regard, one or more of the parent 10 and child 12 may be notified, via email for example, when set times have elapsed and contributions to charities have not been made. Such a notification system allows the contributions to be directed to the desired charities and for the education process to take place. For example, the parent 10 may be notified at 3, 6, and 11 months after the start of the process via email. At some further set time, the contributions may be automatically directed to, in for example a pro rata manner, to the charities of the organization.

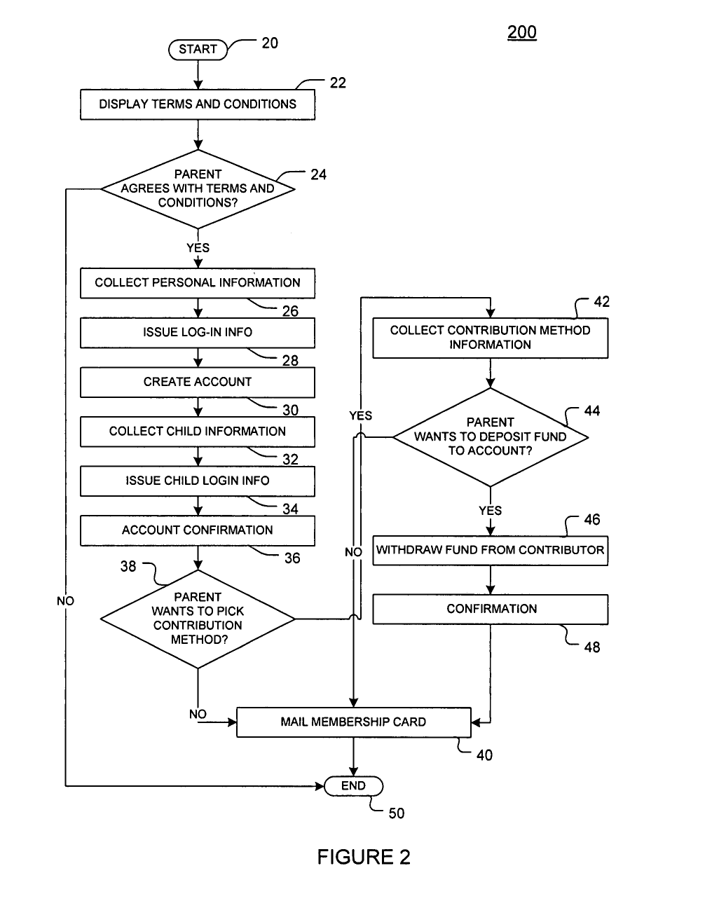

FIG. 2 illustrates a flow chart depicting how a contributor, such as the parent 10, opens an account with the organization 14 according to an embodiment of the invention. As mentioned above, the parent 10 and the child 12 are associated with the same account. The process of creating an account may start when the parent 10 visits the web site of the charity education organization 14 (step 20), such as the web page 400 shown in FIG. 4, where the object 86 may include a link to a web page for purchasing the membership card. Upon entering the membership card purchase web page, terms and conditions for using the service provided by the organization 14 may be displayed (step 22). The terms and conditions may include notices (e.g., an extra fee for credit card process, operational cost or the like) and policies (e.g. automatic cancellation of inactive accounts, discretional disposal of the balances for abandoned accounts, or the like). Upon agreeing with the terms and conditions (step 24), personal information (e.g., name, phone number, address, email address, or the like) of the parent 10 may be collected via an on-line data entry form (step 26). Then, a login ID and password may be issued to the parent 10 (step 28). The login ID and password may be created by the organization 14 or selected by the parent 10. Upon collecting the personal information and issuing the login information, a new account may be created for the parent 10 (step 30).

Subsequently, the personal information (e.g. name, phone number, address, email address, or the like) of the child 12 may be collected via another on-line data entry form (step 32).

Then log-in information for the child 12 may be issued (step 34). The log-in information for the child 12 may be simpler than that of the parent 10 for easier account access. For example, the log-in information for the child 12 may be a series of numbers without any secondary code such as a password. Once the account is created and the access information for the parent 10 and the child 12 are issued, the parent 10 may be notified that the account has been successfully created, via mail, email, phone call or the like (step 36). Then, the parent 10 may be asked if he or she wants to pick a contribution method, such as credit card, debit card, e-check, money order, on-line payment method, or the like (step 38). If the parent 10 does not want to proceed further, he may end the process and the organization 14 may mail a membership card to the parent 10 (step 40).

If the parent 10 wants to select the contribution method, another on-line data entry form may be displayed to collect payment information, such as name, address, credit card number, expiration date, or the like (step 42). Subsequently, the parent 10 may select the amount of funds he or she wants to deposit for the account (step 44). The selected amount of funds may be charged to the parent 10 via the selected contribution method and credited to the selected account (step 46). Once the funds withdrawal and deposition are complete, the parent 10 may be notified to confirm the contribution via one or more of mail, email, telephone call or the like (step 48). If the parent 10 chooses to select the contribution method later, the membership card is mailed to the parent 10 (step 40) and the process is finished (step 50).

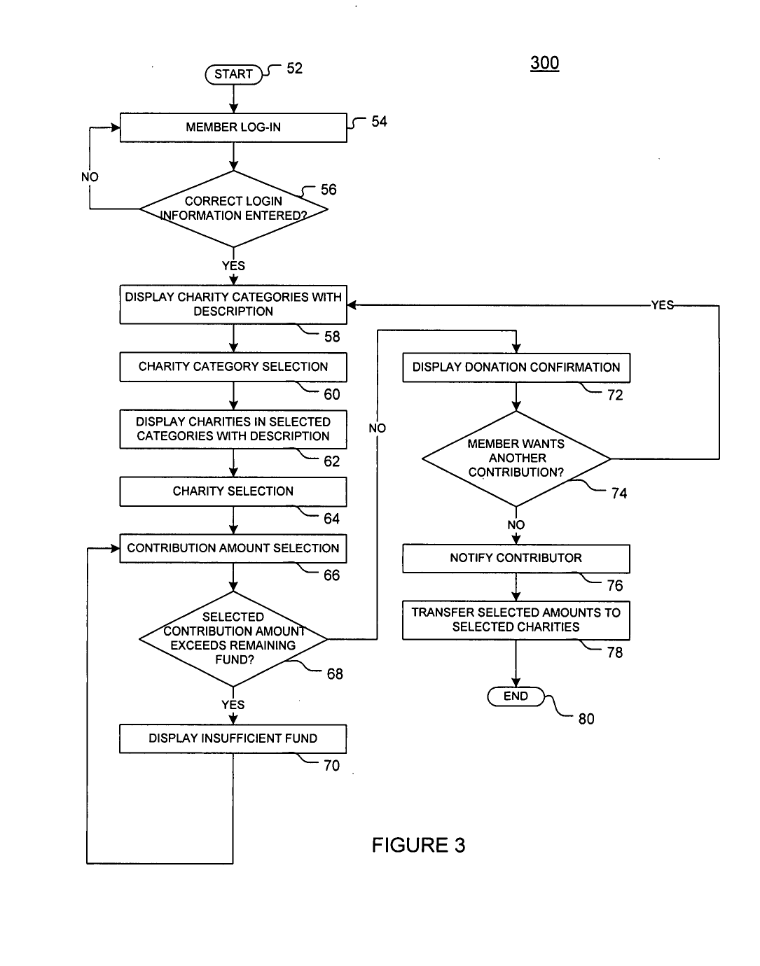

FIG. 3 depicts how a member such as the child 12 obtains educational information and makes a charity decision using the educational service provided by the organization 14 according to an embodiment of the invention. The process starts when the child 12 receives the login information and accesses the web site of the organization 14 (step 52). As mentioned above, the login information may be shown in the membership card previously mailed to the child 12 or the parent 10. Once the child 12 visits the web site, a login page may be displayed where the child 12 may enter the login code (step 54). If a correct login code is entered (step 56), a web page, such as the web page 500 shown in FIG. 5, where the child 12 may select one of the charity categories may be displayed (step 58). Upon selecting a category, a web page, such as the web page 600 shown in FIG. 6, is presented where the child 12 may select one of the sub-categories.

By selecting one of the sub-categories, another new web page, such as web page 700 shown in FIG. 7, is presented where the child 12 may select one of the charitable activities or organizations (step 64) and a donation amount (step 66). The selected amount of the donation is compared to the account balance to see if the donation amount exceeds the account balance (step 68). If the selected donation amount exceeds the account balance, an insufficient funds message may be displayed (step 70) with a request to enter a new donation amount. If the selected donation amount does not exceed the account balance, a message to confirm the selected amount is correct may be displayed (step 72). If the child 12 confirms the selected amount, the child 12 may be asked if he or she wants to make another donation (step 74). If the child 12 wishes to make another donation, the web page, such as the web page 500 shown in FIG. 5 may be displayed for further selection. If the child 12 does not wish to make another donation, the contribution process is completed and the parent 10 is notified about the selected charitable activity and donation amount by the child 12 (step 76), and the selected amount of donation is transferred to the selected charity (step 78).

As described above, the invention discloses an approach for providing educational services to parents and their children online. Such educational service is intended primarily for introducing charitable activities and organizations as many as possible and at the same time as easy as possible. Also, such educational service enables the children to make donations as easy as possible.

While the invention has been described in terms of exemplary embodiments, those skilled in the art will recognize that the invention can be practiced with modifications in the spirit and scope of the appended claims. These examples given above are merely illustrative and are not meant to be an exhaustive list of all possible designs, embodiments, applications or modifications of the invention.

What is claimed is:

1. A computer-implemented method for charity education and donation, comprising the steps of:
displaying a plurality of objects, each object corresponding to a charity and linked to educational content related to the corresponding charity;
in response to a member's selection of one of the objects, displaying the educational content related to the corresponding charity; and
in response to the member's selection of an amount of donation for the selected charity, transferring the selected amount of donation to the selected charity.

2. The computer-implemented method of claim 1, the step of displaying the plurality of objects comprises:
displaying a plurality of first objects, wherein each first object corresponds to a charity category and is linked to first educational content related to the corresponding charity category; and
in response to the member's selection of one of the charity categories, displaying a plurality of second objects, wherein each second object corresponds to the charity and is linked to second educational content related to the corresponding charity.

3. The computer-implemented method of claim 1, further comprising the steps of:
creating an account for a contributor;
in response to a contributor's selection of an amount of contribution, transferring the selected amount of the contribution from the contributor and crediting the selected amount to the account of the contributor; and
providing the member with access information for selecting an amount of donation for a selected charity.

4. The computer-implemented method of claim 3, wherein the step of providing the member with the access information comprises issuing a member card to the member, the member card containing at least information for selecting the amount of donation for the selected charity.

5. The computer-implemented method of claim 4, wherein the access information includes an access code unique to the member.

6. The computer-implemented method of claim 3, further comprising step of invalidating the member's selection of the amount of donation when the selected amount of donation exceeds a balance of the account.

7. The computer-implemented method of claim 1, wherein each of the objects is at least one of a graphical illustration and a text thematically related to an attribute of the corresponding charity.

8. The computer-implemented method of claim 1, wherein the education content includes at least one of a textual description of the charity's activity, a graphic illustration thematically related to an attribute of the charity and a location of the charity's activity.

9. The computer-implemented method of claim 2, wherein each of the first objects is at least one of a graphical illustration and a text thematically related to an attribute of the corresponding charity category.

10. The computer-implemented method of claim 2, wherein the first education content includes at least one of a textual description of the charity category and a graphical illustration thematically related to an attribute of the charity category.

11. The computer-implemented method of claim 3, further comprising the step of notifying the member when the contributor has made a contribution.

12. The computer-implemented method of claim 3, further comprising the step of notifying the member when the contributor has not made a contribution after a predetermined amount of time.
